(19) United States
(12) Patent Application Publication
(10) Pub. No.: US 2021/0278039 A1
(43) Pub. Date: Sep. 9, 2021

(54) Shoulder Rig

(71) Applicant: Jeffrey Overall, Costa Mesa, CA (US)

(72) Inventor: Tyler Wilson, Huntington Beach, CA (US)

(73) Assignee: Polar Pro Filters, Inc., Costa Mesa, CA (US)

(21) Appl. No.: 17/316,997

(22) Filed: May 11, 2021

(51) Int. Cl. F16M 13/04; G03B 17/56; F16M 11/12

(52) U.S. Cl. CPC F16M 13/04; F16M 11/128; G03B 17/561

(57) ABSTRACT

A shoulder rig camera mount. An adjustable shoulder pad enables multiple shoulder mounting orientations. Handles are capable of movement around two axes.

### BACKGROUND

Camera stabilizing mounts are used to improve the recording of visual content. Body mounted stabilization systems allow a videographers and photographers to better control and weight management of heavy cameras. Shoulder rigs allow a videographer to stabilize a camera against their shoulder. A shoulder pad rests against the content creator's shoulder. Forward extending rods feature control handles. The camera and other optical equipment may be mounted directly to the rods, or the shoulder rig may feature an additional mounting device.

Shoulder rigs are relatively large. The dimensions can make storage and transportation difficult. Additionally, the dimensions of a shoulder rig may only allow content capture in the shoulder mounted orientation. This can be restrictive to a content creator who desires to orient the camera lower on their body. Inability to adjust the shoulder rig dimensions may also make filming difficult for content creators of different heights to comfortably manipulate the shoulder rig handles while the shoulder rig is in the traditional shoulder mounted orientation.

### SUMMARY OF THE INVENTION:

The current invention provides a shoulder rig with an adjustable shoulder pad and enhanced handle adjustment ability. A shoulder pad joint allows movement of the pad from a folded to wrap position. The folded position enables mounting higher on the shoulder. The wrap position enables lower positioning of the camera of the shoulder. A lower pad extends down and around the user's shoulder, providing greater stability. The wrap position may also enable the user to stabilize the shoulder rig against their chest, enabling lower angle shots and quicker interchange between shoulder mounted filming and handheld filming.

The handles are capable of movement around a flip axis and spin axis. The handles may be locked in an operational position (extending roughly perpendicularly downward from the rods), a storage position (raised until they are relatively parallel with the rods), and a plurality of positions other orientations.

### BRIEF DESCRIPTION OF THE DRAWINGS:

FIG. 1A is a front, right and top perspective view of a shoulder rig in a base position.

FIG. 1B is a right-side view of a shoulder rig in a base position.

FIG. 2A is a front view of a shoulder rig in a low hands position.

FIG. 2B is a right-side view of a shoulder rig in a low hands position.

FIG. 3A is a front, right and top perspective view of a shoulder rig in a wrap position.

FIG. 3B is a right-side view of a shoulder rig in a wrap position.

FIG. 3C is a front, right and bottom perspective view of a shoulder rig in a wrap position.

FIG. 4A is a right-side view of a shoulder rig in a chest position.

FIG. 4B is a top view of a shoulder rig in a chest position.

FIG. 4C is a back, left, bottom perspective view of a shoulder rig in a chest position.

FIG. 5 is a front, right and top perspective view of a shoulder rig with the handles in an alternative position.

FIG. 6 is a front, right and top perspective exploded view of a shoulder pad and video plate.

FIG. 7 is back, right and top perspective exploded view of rods and a riser.

FIG. 8 is a front, left and bottom perspective exploded view of a handle.

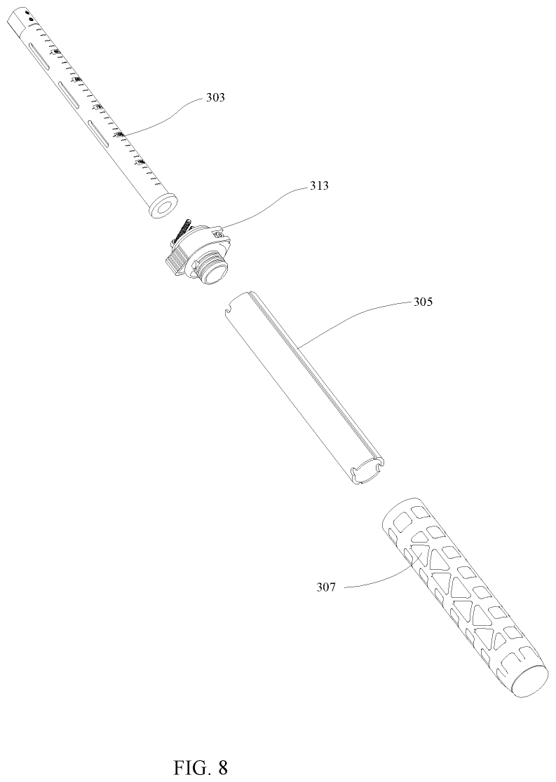

FIG. 9 is a front, right and top perspective exploded view of a front bar and handle top assembly.

### DRAWING NUMERALS

50 length
51 width
52 height
100 front cover
102 front button
104 button spring
110 right lock arm
111 left lock arm
130 arm spring one
131 arm spring two
140 front bar
142 right bar aperture
144 left bar aperture
150 right bar latch
151 left bar latch
210 right flip arm
211 left flip arm
212 right handle top
213 left handle top
215 left rosette
219 left rosette screw
220 right handle button
221 left handle button
222 right handle slider button spring
223 left handle slider button spring
300 right handle
301 left handle
302 right handle internalrod
303 left handle internalrod
304 right handle tube
306 right handle grip
312 right handle latch
313 left handle latch
500 shoulder pad
501 shoulder pad joint
505 video plate cavity
507 video plate
508 video plate button
509 video plate coupling screw
510 video plate spring
512 shoulder pad pin one
514 shoulder pad pin two
516 pin spring
524 joint button one
526 joint button two
540 tension spring one
542 tension spring two
544 button screw one
545 hub one
546 button screw two
547 hub two
550 lower pad
551 lower pad inner surface
552 upper pad
553 upper pad inner surface
560 shoulder pad slide plate
562 shoulder pad slide plate screw
564 shoulder pad slide plate spring one
566 shoulder pad slide plate spring two
570 guide holes
600 auxiliary plate
602 mounting platform
606 mount release button
607 mount stop
610 upper quick release clamp
614 riser latch
615 plate lock
618 riser lock spring
620 right rod latch
622 left rod latch
640 riser
642 right riser aperture
644 left riser aperture
680 left rod
682 right rod
683 rod cap
700 spin axis
701 flip axis

### DETAILED DESCRIPTION OF THE DRAWINGS

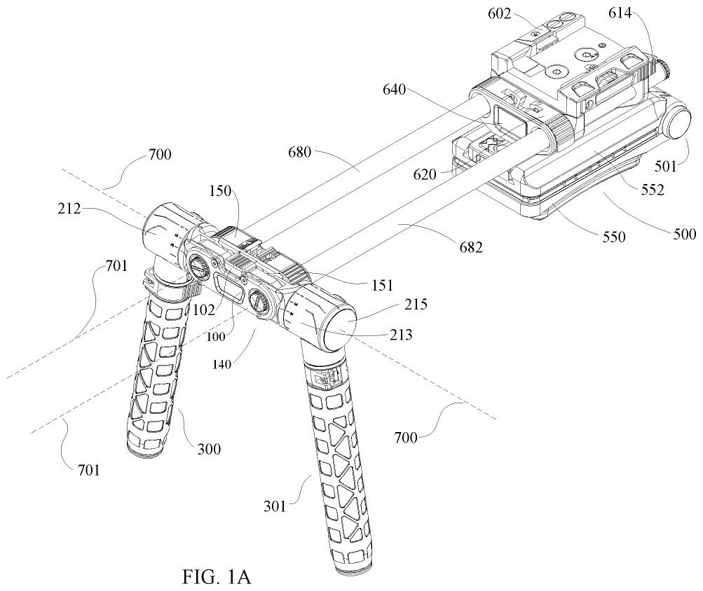

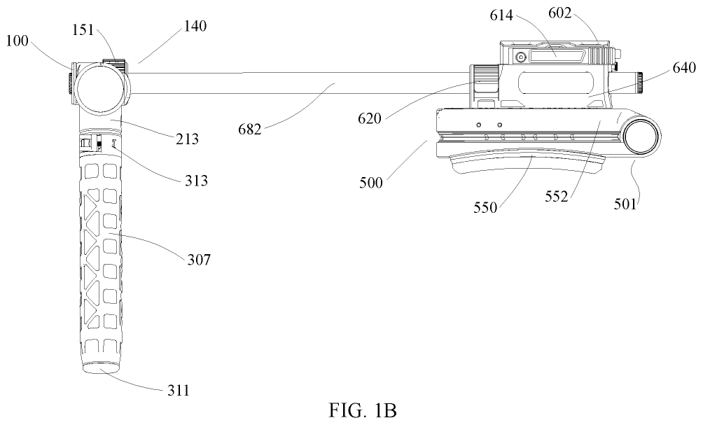

FIGS. 1A and 1B depict a shoulder rig in a base position. Two rods (680, 682) connect a riser 640 and front bar 140. Two handles (300, 301) operatively couple with and extend from the front bar 140. “Operatively couple” is used herein to refer to components capable of coupling in multiple positions relative to each other. A shoulder pad 500 couples with the bottom of the riser 640. The shoulder pad 550 is comprised of a lower pad 550 and an upper pad 552. A shoulder joint 501 operatively couples the lower pad 550 and upper pad 552. The shoulder joint 501 may enable the lower pad 550 to move through a movement range defined by a folded position and a wrap position. The folded position refers to the position shown in FIGS. 1A and 1B, in which the lower pad inner surface 551 and the upper pad inner surface 553 abut or are oriented substantially parallel to each other. A mounting platform 602 comprises the upper portion of the riser 640. A auxiliary plate 600 may removably couple with the mounting platform 602. The auxiliary plate 600 may be capable of coupling a camera or other device(s). The riser 640 may comprise alternative auxiliary device coupling means.

In a base position the bottom surface of the lower pad 550 is configured to abut the shoulder while a user holds one or both of the handles (300, 301). The handles may be oriented down and outwards from the intervening front bar 140 in an operation position, as seen in FIG. 1A. This orientation enables the handles (300, 301) to be gripped in a neutral grip, for ergonomic comfort. The bottom surface of the lower pad 550 may be concave to better contour a user's shoulder.

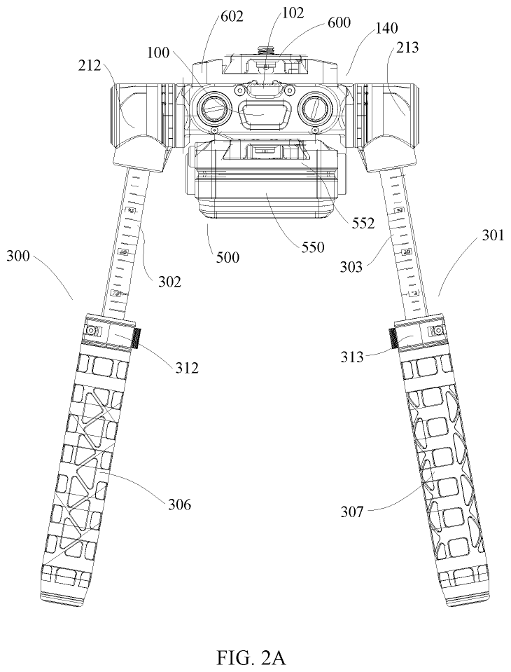

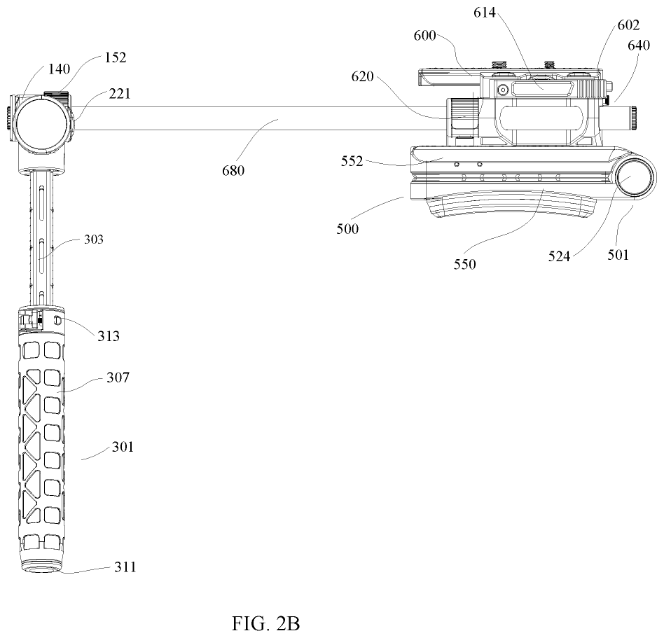

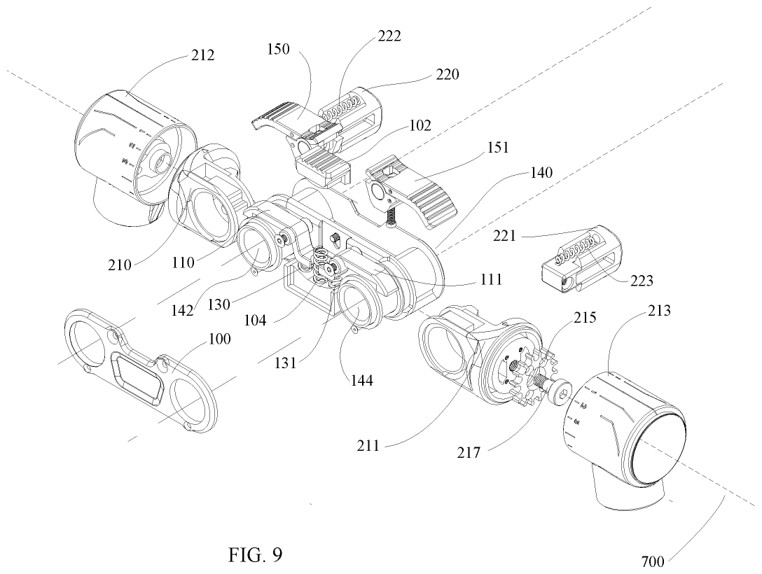

FIGS. 2A and 2B depict a shoulder rig in a low hands position. Each handle comprises an internalrod (302, 303), a latch (312, 313), a tube (304, 305), and a grip (306, 307) (see FIG. 9). The internalrod (302, 303) couples with a handle top (212, 213). The latch (312, 313) encircles and operatively couples the internalrod (302, 303). In an unlocked position the latch (312, 313) may expand to a diameter enabling the latch (312, 313) to be moved up and down the internalrod (302, 303). In a locked position the latch (312, 313) may engage the internalrod (302, 303), whereby locking the latch (312, 313) in a specific position relative to the handle top (212, 213). A flange at one end of the internalrod (302, 303) may prevent the latch (312, 313) from dislodging.

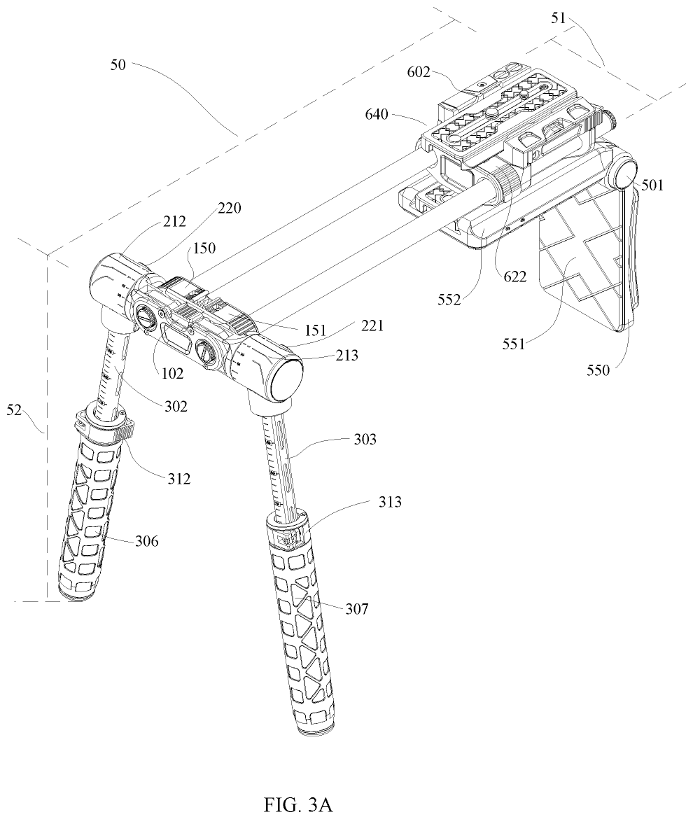

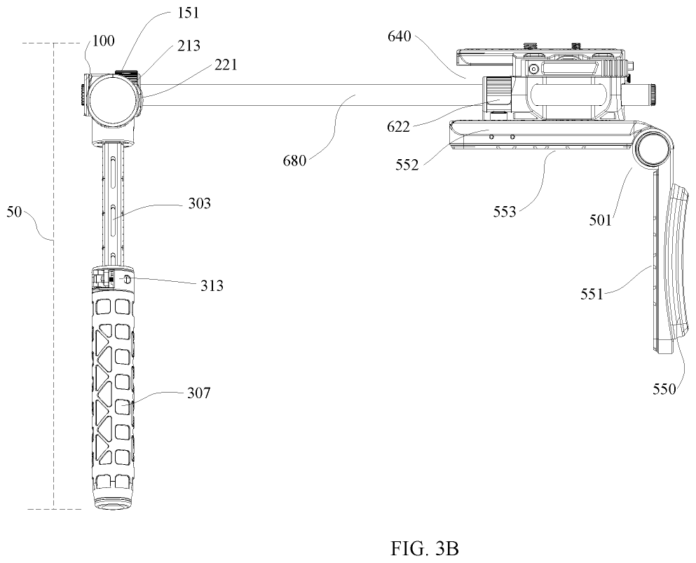

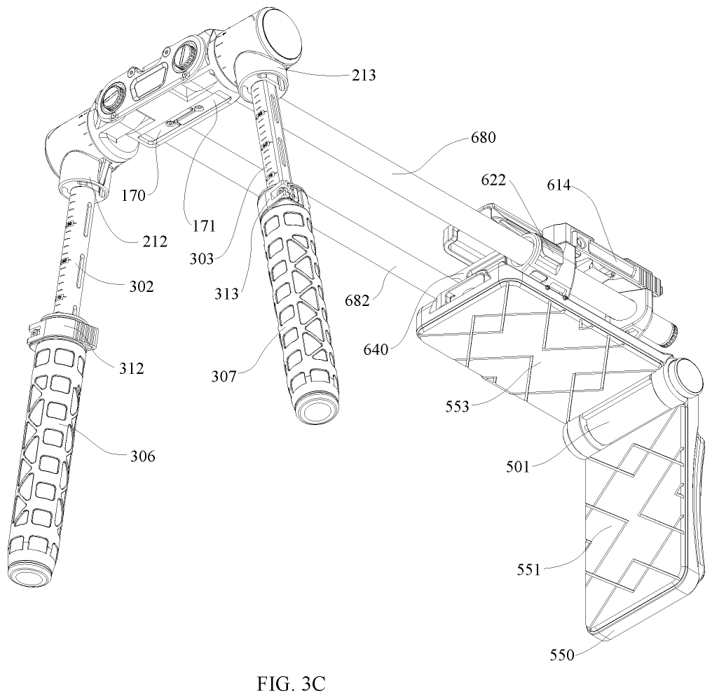

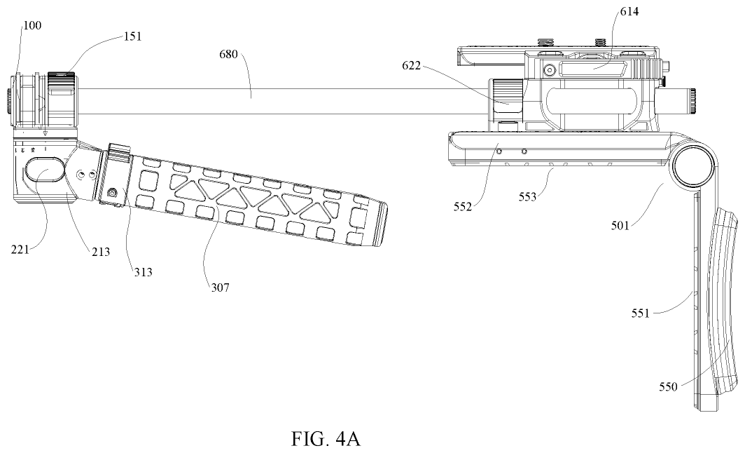

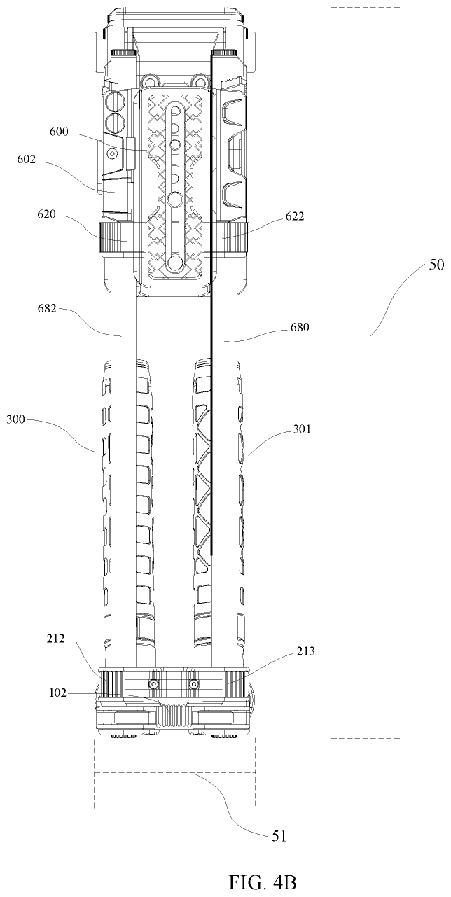

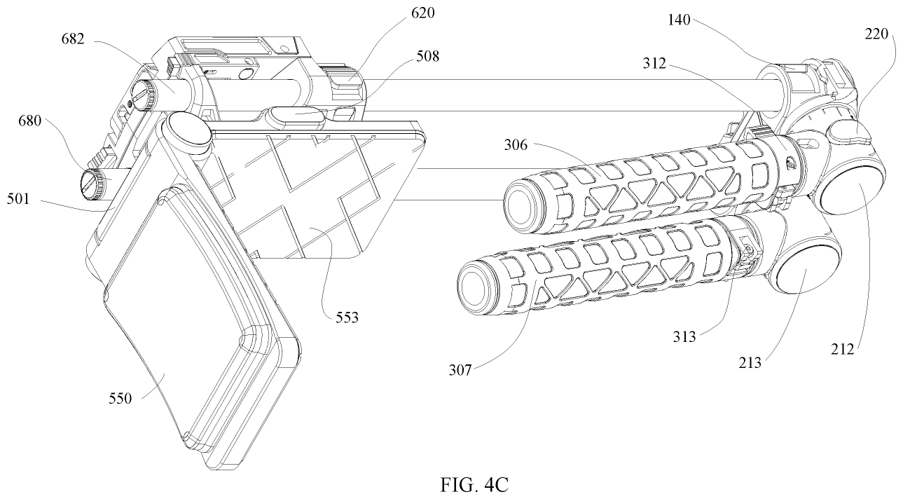

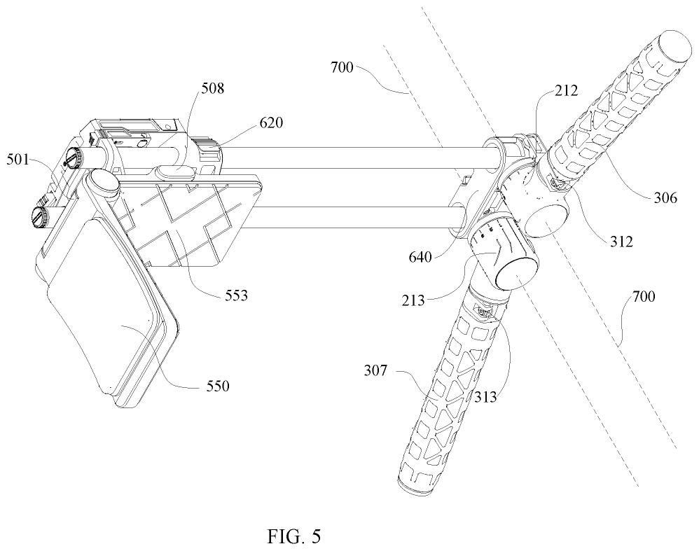

The latch (312, 313) may couple with a tube (304, 305). A tube's (304, 305) dimensions may enable it to encase the internalrod (302, 303) and move in tandem with the latch (312, 313). A grip (306, 307) may encase the tube (304, 305). The grip (306, 307) may enhance haptic comfort and control ability. From a base position, one or both latches (312, 313) may be adjusted down the internalrod (302, 303) into a low hand position, to allow the user to grip the handle(s) in a relatively lower position. The surface of the internalrods (302, 303) may feature Metric, U.S. Customary, or other measurements to allow the user to coordinate orientation of the handles (300, 301). Each handle (300, 301) may extend from a high hands position (see FIGS. 1A-B, FIGS. 4A and 4B, and FIG. 5) to an extended low hands position in which the length of one or both handles is increased (see FIGS. 2A-3C). A low hands position may create greater control of the shoulder rig or enable different filming angles by allowing a user to grip the handles at a position closer to their waist. A “low hands position” is created when one or both of the handles are extended from the shortest, base position orientation seen in FIGS. 1A-B.

FIGS. 3A-C depict a shoulder rig in a wrap position. The lower pad 550 is rotated down and away from the upper pad 552, until the pad surfaces (551, 553) are substantially perpendicular. The shoulder joint 501 enables the shoulder paid to move within a movement range relative to the upper pad 552. One limit of the rotation range may be defined by the roughly perpendicular orientation of the wrap position. “Roughly perpendicular” may mean the pad surfaces (551, 553) are oriented at any range from 65 degrees to 115 degrees. The other limit may be defined by the inner pad surfaces (551, 553) abutting and/or being parallel, as in the base position. The pad joint 501 may comprise locking means, whereby the lower pad 550 can be locked in multiple positions. Hubs (545, 547) may extend from the back perimeter of the lower pad 550. The hubs may house lock buttons (524, 526). A pin spring 516 may urge shoulder pad pins (512, 514) outward to engage with the hubs (545, 547), thereby locking the joint in a particular orientation. Pressing one or both of the lock buttons (524, 526) inward with a predetermined amount of force sufficient to overcome the urging force of the pin spring 516 may cause the shoulder pad pins (512, 514) to disengage from the hubs (545, 547) and enable rotation of the lower pad 550.

Each hub (545, 547) may comprise a plurality of guide holes 570. In an unactivated position the pad pins (512, 514) may engage the guide holes 570 to lock the pad 500 in a particular orientation. The guide holes 570 may be configured to lock the pad 500 in a folded position and a wrap position, and at other intervening orientations.

A button screw (544, 546) may extend inward from each lock button (524, 526). Each button screw (544, 546) may insert into a socket in the upper pad 552. The button screws (544, 546) may enable stable rotation of the lower pad 550 until the pad pins (512, 514) reengage guide holes 570, whereby locking the lower pad 550.

One or both of the lock buttons (524, 526) may be pressed inward, i.e. towards the other lock button, with a predetermined amount of force to disengage the pad joint 501 from a stable position and enable movement of the lower pad 550. The wrap position may enable a user's shoulder to contact the inner surface 553 of the upper pad 551 and the user's shoulder and upper back to contact the inner surface of lower pad 551.

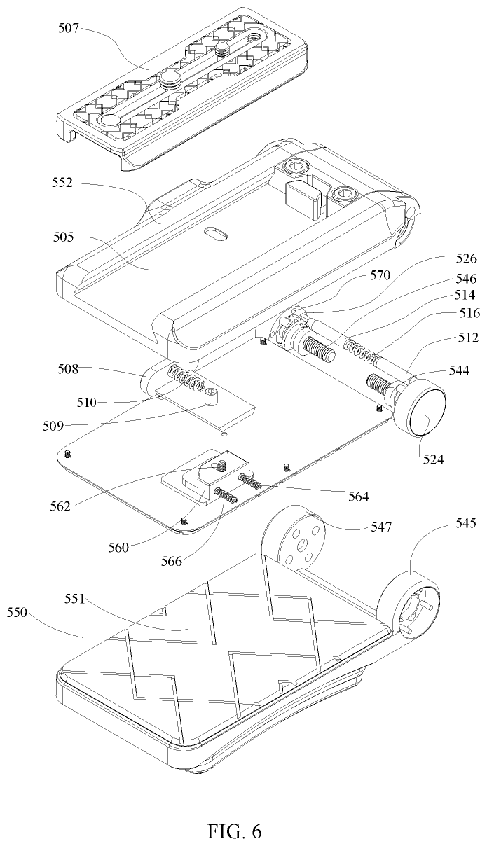

The pad 500 may couple with the riser 640 via a video plate 507. A plate cavity 505 at the top of the upper pad 552 may be configured to house a video plate 507. A video plate coupling screw 506 may protrude through an aperture in the surface of the upper plate 552 and into the plate cavity 505 (see FIG. 6). The video plate coupling screw 506 may couple with a video plate button 508. A video plate spring 510 may bias the video plate button 508 and video plate coupling screw 506 into a locked position. In a locked position the video plate coupling screw may couple with an installed video plate 507. The video plate coupling screw 506 may engage the bottom surface of the video plate 507 to couple it in the plate cavity 505. A predetermined amount of force may be applied to the video plate button 508 to move video coupling plate screw 506 out of the locked position and allow the video plate 507 to be uncoupled. The bottom surface of the video plate 507 may be beveled to move the plate screw from a locked position to an unlocked position back to a locked position while the video plate 507 is being slidably installed into the plate cavity 505. The video plate 507 may be permanently coupled with the riser 640. The video plate 507 may removably couple with the riser 640. The exemplary plate 640 removably couples with the riser via screws.

The upper pad 552 may house a slide plate 560. The shoulder pad slide plate 560 may extend into the plate cavity 505. Two shoulder pad slide plate springs (564, 566) urge the slide plate 560 into the cavity. The plate springs (564, 566) retract to enable installation of a video plate 507. The shoulder pad slide plate 560 exerts additional pressure on an installed video plate 507 to stabilize and prevent inadvertent movement an installed video plate 507 and riser 640 while operating the shoulder rig.

The shoulder pad slide plate 560 and a portion of the perimeter of the shoulder pad cavity 505 may be beveled at an angle corresponding to the sides of the video plate 507 to prevent inadvertent uncoupling.

A chest position is depicted in FIGS. 4A and 4B. The lower pad 550 is locked at perpendicular to the upper pad 552, as it may be in a wrap position. The handles (300, 301) are retracted to a storage position, in which they are below and substantially parallel to the rods (680, 682). A user may hold the handles (300, 301) in a supinated grip and press the bottom surface of the lower pad 550 into their chest. The chest position may allow a user to capture lower angles and more quickly disengage the rig from the user's body to film in alternative positions. The handles (300, 301) may be returned to the high hand position to create space between the handles (300, 301) and the pad 500.

Each handle (300, 301) may be capable of movement around two axes—a spin axis 700 and a flip axis 701. Each handle top (213, 212) operatively couples with a flip arm (210, 211). A rosette (214, 215) may be annularly mounted around a rosette screw (216, 217). The rosette screw (216, 217) may engage an inner surface of the handle top (212, 213) to lock the handle (300, 301) at an array of predetermined positions. A handle button (220, 221) may extend from the handle top (212, 213). A handle button spring (222, 223) may bias the handle button (220, 221) to engage the rosette (214, 215) and lock the handle (300, 301) in position. A predetermined amount of force may be applied to the handle button (220, 221) to disengage it from a locked position, enabling the handle top to rotate around the spin axis 700. When the desired orientation relative to the spin axis 700—such as the retracted position in FIGS. 4A-B or the extended position in FIGS. 1A-3B—is achieved, the force is removed and the handle button (220, 221) reengages the rosette (214, 215) to lock it in position.

While the flip axes 701 remain constant relative to the rods, the spin axes 700 may change relative to the rest of the shoulder rig as the handle is rotated around the flip axis (701). For example, the spin axes (300, 301) of the two handles are confluent and extend through the length of the front bar 140 and out to the left and right side of the shoulder rig (see FIG. 1A). In contrast, when a flip arm is rotated inward 90 degrees, the spin axis 701 of the rotated handle will also rotate 90 degrees (see FIG. 5). Lock arms (110, 111) may lock the flip arms (210, 211) in the operational position. Arm springs (130, 131) may urge the lock arms (110, 111) in a lock position. A front button (102) may engage the lock arms (110, 111) and force them out of a locked position, enabling the flip arms (210, 211) to rotate around their spin axis 700. A button spring 104 may urge the front button 102 into a neutral position, in which it doesn't engage the lock arms (110, 111). A predetermined amount of force must be applied to the front button 102 to overcome the force of the button spring 104 and arm springs (130, 131) to enable the front button to engage the lock arms (110, 111).

Each flip arm (210, 211) operatively couples with the front bar 140. Each flip arm (210, 211) may encircle a rod aperture (142, 144). Each flip arm may be capable of rotation around a flip axis 701. A spring biased lock arm (110, 111) may engage each flip arm (210, 211) in an unactivated position and lock the flip arm (210, 211) in place. A predetermined force may be amount of force may be applied to the lock arm (110, 111) to disengage it from the flip arm (210, 211), thus enabling movement of the flip arm (210, 211) around the flip axis 701. The flip arms (210, 211) may be rotated inward, until the handles (300, 301) are positioned under the rods, as depicted in FIGS. 4A-B. The user may then remove the predetermined force from the lock arm (110, 111) enabling it to reengage the flip arm (210, 211) and lock it in position. The retracted position of the handles (300, 301) shown in the chest position configurations reduce the area of the shoulder rig, and thus may be most advantageous when storing and/or transporting the shoulder rig.

The riser 640 operatively couples the rods (680, 682). The rods (680, 682) may pass through riser apertures (642, 644). A rod latch (620, 622) may couple each riser aperture (642, 644). In a locked position, a rod latch (620, 622) may compress the riser aperture (642, 644) so that it abuts the circumferential surface of the rod (680, 682) and pressure fit locks the riser 640 in a position relative to the rods (680, 682). In an unlocked position, the rod latch (620, 622) enables the riser apertures to expand to a diameter permitting movement of the rod (680, 682) therethrough. When both rod latches (620, 622) are in an unlocked position the riser 640, and the shoulder 500 pad, may move on the rods (680, 682). The riser 640 may be adjusted forward, i.e. closer to the front bar 140, or backwards on the rods (680, 682). The latches (620, 622) may be locked when the desired orientation is realized.

Similarly, there are two bar apertures (142, 144) in the front bar 140. A bar latch (150, 151) may couple each bar aperture (142, 144). In a locked position, a bar latch (150, 151) may compress the bar aperture (142, 144) so that it abuts the circumference of the rod and pressure fit locks the riser 640 in a position relative to the rods (680, 682). In an unlocked position, the bar latch (150, 151) enables the bar apertures to expand to a diameter permitting movement of the rod (680, 682) therethrough. When both bar latches (150, 151) are in an unlocked position the front bar 140 may move relative to the rods (680, 682). The riser 640 may be adjusted backwards, i.e. closer to the riser 640, or forwards on the rods (680, 682). The bar latches (150, 151) may be locked when the desired orientation front bar and is realized. Rod caps 683 on the ends of the rods may prevent the front bar 140 and riser 640 from unintentionally dislodging from the rods (680, 682).

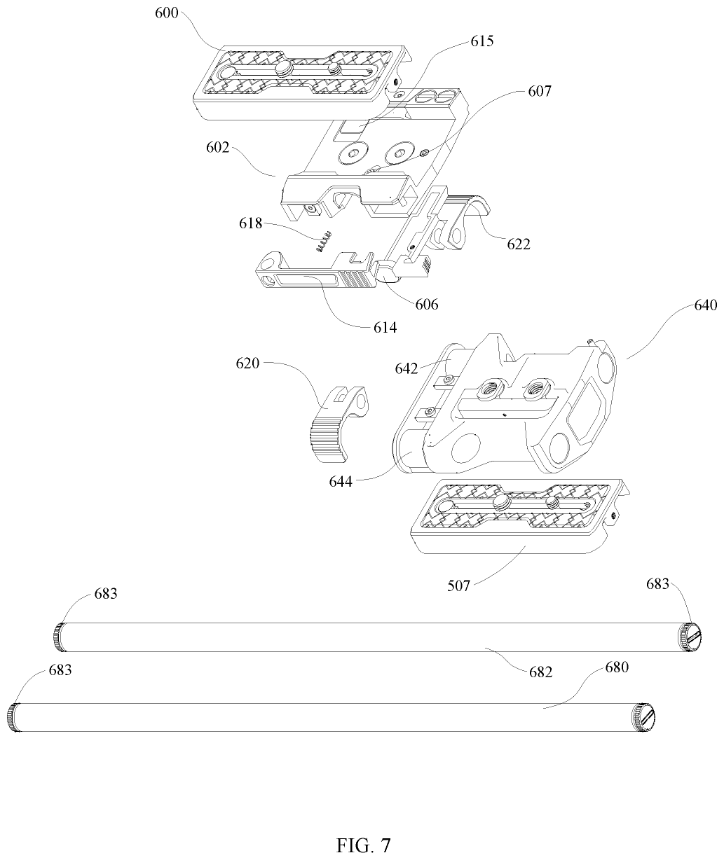

The riser 640 may removably couple an auxiliary plate 600. A mounting release button 606 may couple with a mount stop 607. The mounting release button may extend from the side surface of the mounting platform 602 (see FIGS. 7 and 10). The mounting stop 607 may extend from an inner surface of the mounting platform and be disposed to engage an installed auxiliary plate 600. The mounting release button 606 may be spring loaded, the spring urging the mounting stop 607 into a position that couples an installed auxiliary plate 600 with the mounting platform 602. A predetermined amount of force may be applied to a mounting release button 606 to overcome the spring and force the mounting stop out of a locked position, allowing a user to uncouple the auxiliary plate 600 from the mounting platform 602.

A riser latch 614 may extend from the side of the mounting platform 602. The riser latch 614 may couple with a plate lock 615. In a locked position the riser latch 614 may urge the plate lock 615 inwards towards an installed auxiliary plate 600 and couple the plate 600. The riser latch 614 may be moved out of a locked position, whereby the plate lock 615 uncouples the installed auxiliary plate 600 and the plate 600 may be removed. The plate lock 615 and mounting stop 607 may individually or collectively couple an installed auxiliary plate 600.

The video plate 507 may be an arca plate or other quick release mounting system capable of coupling with a tripod or other stand or mount.

The foregoing disclosure is intended to be illustrative and not limiting the scope of the invention. Merely exemplary embodiments and methods related to the invention are discussed and described. As will be understood by those familiar to the art, the disclosed subject matter may be embodied in other forms or methods without departing from the essence of the invention.

I claim:

1. A shoulder rig, comprising:
a. a shoulder pad comprising a lower pad and an upper pad;
b. a shoulder joint operatively coupling the lower pad and upper pad, the shoulder joint enabling the lower pad to move from a folded position to a wrap position;
c. the shoulder pad coupling with a riser, the riser comprising auxiliary device coupling means;
d. at least one rod, the at least one rod coupling with the riser and a front bar;
e. the front bar comprising two flip arms;
f. two handles, each of the two handles comprising a handle top;
g. each of the two flip arms operatively coupling with a handle top so the handle can move around both a flip axis;
h. each handle top enabling movement of the handle around a spin axis.

2. A shoulder rig, comprising:
a. a riser, the riser comprising auxiliary device coupling means;
b. a shoulder pad comprising;
i. a lower pad;
ii. and upper pad;
iii. a shoulder joint as means of operatively coupling the lower pad and upper pad, the shoulder joint enabling movement of the lower pad relative to the upper pad;
c. the shoulder pad coupling with the riser;
d. a rod, the rod coupling with the riser and a front bar;
e. the front bar comprising a left flip arm and a right flip arm;
f. the left flip arm coupling with a left handle top;
g. the right flip arm coupling a right handle top;
h. the left flip arm and right flip arm both being capable of rotation around a flip axis;
i. the left handle top and the right handle top being capable of movement around spin axis.

3. The shoulder rig in claim 2, wherein both the right handle and the left handle may be extended to increase their length.

4. The shoulder rig in claim 2, wherein the range of motion of the lower pad is defined by a folded position and a wrap position.

5. A shoulder rig, comprising:
a. two rods, the rods coupling a front bar and a riser;
b. the front bar comprising two flip arms, each of the two flip arms coupling a handle;
c. each of the two flips arms capable of rotation around a flip axis;
d. each handle capable of extending from a high hand position to a plurality of low hand positions;
e. a shoulder pad, the shoulder pad comprising a lower pad and an upper pad;
f. a shoulder pad joint as means of operatively coupling the lower pad and the upper pad;
g. the shoulder joint as means rotating the lower pad through a movement range, a wrap position defining one limit of the movement range, a folded position defining the other limit of the movement range.
